(19) United States
(12) Patent Application Publication
(10) Pub. No.: US 2020/0143952 A1
(43) Pub. Date: May 7, 2020

(54) Method for Treating Radioactive Liquid Waste

(71) Applicant: Korea Atomic Energy Research Institute, Daejeon (KR)

(72) Inventors: Seung Joo Lim, Jeollabuk-do (KR); Tak Hyun Kim, Jeollabuk-do (KR); Kang Lee, Jeollabuk-do (KR); Dong Woo Kim, Jeollabuk-do (KR); Joon Pyo Jeun, Jeollabuk-do (KR); In Tae Hwang, Jeollabuk-do (KR); Joon Yong Sohn, Jeollabuk-do (KR); Kyung Hoon Jeong, Gyeongsangbuk-do (KR)

(73) Assignee: Korea Atomic Energy Research Institute, Daejeon (KR)

(21) Appl. No.: 16/674,251

(22) Filed: Nov. 5, 2019

(30) Foreign Application Priority Data
Nov. 7, 2018 (KR) 10-2018-0135732

(51) Int. Cl. G21F 9/06

(52) U.S. Cl. CPC G21F 9/06

(57) ABSTRACT

The present invention relates to a technology for treating radioactive liquid waste containing a hardly degradable compound, and more specifically, to a technology for treating radioactive liquid waste containing a material such as an organic decontamination agent, an inorganic decontamination agent, liquid scintillation counter liquid waste, and the like generated at nuclear power plants, nuclear facilities, facilities at which radiation (radioactivity) is used, and the like. The method for treating radioactive liquid waste of the present invention includes adding two or more selected from the group consisting of a metal ion, an oxidizing agent, air, oxygen, or nitrous oxide, and a semiconductor to radioactive liquid waste to prepare a pre-treatment solution, and irradiating the pre-treatment solution with radiation.

### CROSS-REFERENCE TO RELATED APPLICATIONS

This application claims the benefit of Korean Patent Application No. 10-2018-135732, filed on 7 Nov. 2018, in the Korean Intellectual Property Office, the disclosure of which is incorporated herein in its entirety by reference.

### TECHNICAL FIELD

The present invention relates to a technology for treating radioactive liquid waste, and more specifically, to a technology for treating radioactive liquid waste containing an organic decontamination agent, an inorganic decontamination agent, liquid scintillation counter liquid waste, and the like generated at nuclear power plants, nuclear facilities, facilities at which radiation (radioactivity) is used, and the like.

### BACKGROUND ART

A hardly degradable compound is generated due to the use and the like of an organic decontamination agent, an inorganic decontamination agent, and liquid scintillation counter liquid waste at nuclear power plants, nuclear power-related facilities, and facilities at which radiation (radioactivity) is used.

Chemical decontamination is a technique for removing radiation (radioactivity) of devices, installations, or the like contaminated with radiation (radioactivity), and is a technique generating wastewater including the above hardly degradable compound. Also, as a technology for measuring radiation, a liquid scintillation counting technology is widely used. Particularly, due to the use of a liquid scintillation counter, a large amount of wastewater containing liquid scintillation counter liquid waste is generated.

The above hardly degradable compound such as an organic decontamination agent, an inorganic decontamination agent, an organic scintillation material, and the like present in radioactive liquid waste deteriorates the performance of a purification system used in a treatment process in the treatment of radioactive liquid waste, and reacts with metallic radioactive waste generated in another process, thereby making the treatment thereof more difficult. Therefore, the treatment of the hardly degradable compound is important.

In addition, when radioactive liquid waste including the above hardly degradable compound is stored in a drum, the hardly degradable compound and an oxidizing agent are reacted, thereby increasing the pressure inside the drum, so that there is a risk of explosion. Furthermore, in the case of using an evaporation concentration method, which is one of the methods for treating radioactive waste, when a hardly degradable compound is included in waste to be treated, an environmental hormone, such as dioxin, may be discharged. Therefore, the above method may also cause a problem in the treatment of radioactive liquid waste.

Accordingly, there is a need for a technology capable of treating a hardly degradable compound included in radioactive liquid waste in a suitable manner. The domestic chemical decontamination technologies, which have been developed at present, such as system decontamination, parts decontamination, and the like for dismantling nuclear power plants include a low-concentration chemical decontamination technology using an organic complexing agent such as an organic acid or ethylenediamine-N, N, N′,N′-tetraacetic acid (EDTA) and an organic acid-based regeneration low oxidation state metal ion (LOMI) decontamination technology. In recent years, chemical decontamination technologies based on an inorganic matter such as nitric acid, sulfuric acid, hydrochloric acid, and hydrazine have been developed. However, examples of the actual application of an inorganic matter decontamination agent have not been reported, which may be due to the fact that the use of the inorganic matter decontamination agent makes it more different to treat waste liquid containing an inorganic matter. Accordingly, organic acid-based decontamination agents have been used at domestic nuclear power plants so far, and most organic acid-based decontamination technologies which have been used rely on HP-CORD technology mainly for oxalic acid and a UV/hydrogen peroxide process for treating oxalic acid, which are foreign commercialized technologies. An organic acid-based decontamination liquid waste treatment technology developed by AREVA, France, which is the most commonly used technology up to now, is a technology which generates hydroxyl radicals with ultraviolet rays and chemicals of hydrogen peroxide and decomposes oxalic acid, which is a decontamination agent.

However, since these techniques use UV having a high energy level, the irradiation range of ultraviolet rays for generating hydroxyl radicals is very short, so that problems have been reported in that a UV device and a large amount of hydrogen peroxide are required and a long processing duration which is 5 hours or more is required.

Therefore, studies are being continuously conducted in order to improve treatment amount and treatment efficiency for radioactive liquid waste.

### DISCLOSURE OF THE INVENTION

### Technical Problem

An aspect of the present invention provides a method for treating radioactive liquid waste, the method having excellently improved treatment amount and treatment efficiency for radioactive liquid waste.

Another aspect of the present invention provides a method for treating radioactive liquid waste including at least one selected from the group consisting of an organic decontamination agent, an inorganic decontamination agent, and liquid scintillation counter (LSC) liquid waste.

### Technical Solution

According to an aspect of the present invention, there is provided a method for treating radioactive liquid waste, the method including adding two or more selected from the group consisting of a metal ion, an oxidizing agent, air, oxygen, or nitrous oxide, and a semiconductor to radioactive liquid waste to prepare a pre-treatment solution, and irradiating the pre-treatment solution with radiation.

### Advantageous Effects

When the method for treating radioactive liquid waste of the present invention is used, decontamination waste liquid during a decontamination process and/or liquid scintillation counter liquid waste generated may be treated with excellent efficiency. More specifically, an organic matter such as oxalic acid, an inorganic matter such as nitric acid, sulfuric acid, hydrochloric acid, and hydrazine, a liquid scintillation material, and the like may be decomposed.

Also, with a powerful oxidation decomposition effect that cannot be obtained by radiation treatment alone, a radiation fusion treatment system capable of completely treating radioactive liquid waste may be established to safely and efficiently treat radioactive liquid waste.

In addition, since the pH of radioactive waste liquid that may be treated is not limited to acidity, alkali and neutral liquid waste may also be treated, thereby improving accessibility to the method and solving problems such as device corrosion.

### BRIEF DESCRIPTION OF THE DRAWINGS

The following drawings attached to the specification illustrate preferred examples of the present invention by example, and serve to enable technical concepts of the present invention to be further understood together with detailed description of the invention given below, and therefore the present invention should not be interpreted only with matters in such drawings.

FIG. 1 is a graph showing the concentration of oxalic acid over time when the oxalic acid is treated with UV/hydrogen peroxide at pH 3;

FIG. 2 is a graph showing the concentration of oxalic acid according to absorbed dose when the oxalic acid is treated with radiation at pH 3;

FIG. 3 is a graph showing the treatment efficiency for oxalic acid according to absorbed dose when the oxalic acid is treated at pH 9 by being added with a metal ion, an oxidizing agent, or a metal ion and an oxidizing agent, and then being irradiated;

FIG. 4 is a graph showing the concentration of oxalic acid according to absorbed dose when the oxalic acid is treated at pH 9 by being added with a metal ion, an oxidizing agent, or a metal ion and oxygen, and then being irradiated;

FIG. 5 is a graph showing the treatment efficiency for oxalic acid according to absorbed dose when radioactive liquid waste is treated with a metal ion and/or a semiconductor, and radiation;

FIG. 6 is a graph showing the treatment efficiency for oxalic acid according to absorbed dose when radioactive liquid waste injected with air is treated with an oxidizing agent and/or gas (oxygen), and radiation;

FIG. 7 is a graph showing the treatment efficiency for hydrazine according to absorbed dose when radioactive liquid waste including hydrazine is treated with an oxidizing agent and/or gas (oxygen), and radiation;

FIG. 8 is a graph showing the decomposition efficiency for liquid scintillation counter (LSC) according to absorbed dose when liquid waste (pH 3) including the LSC is treated with a metal ion and/or gas (nitrous oxide) and, radiation; and

FIG. 9 is a graph showing the decomposition efficiency for liquid scintillation counter (LSC) according to absorbed dose when liquid waste (pH 7) including the LSC is treated with a metal ion and/or gas (nitrous oxide), and radiation.

### MODE FOR CARRYING OUT THE INVENTION

A method for treating radioactive liquid waste of the present invention includes adding two or more selected from the group consisting of a metal ion, an oxidizing agent, air, oxygen, or nitrous oxide, and a semiconductor to radioactive liquid waste to prepare a pre-treatment solution, and irradiating the pre-treatment solution with radiation.

In the present invention, the ‘radioactive liquid waste’ is liquid waste containing a radioactive material, and includes decontamination waste liquid, liquid scintillation counter waste liquid, and the like.

The ‘decontamination liquid waste’ refers to liquid waste generated during a decontamination process performed at a nuclear dismantling facility, a radiation (radioactivity) facility, and the like, and more specifically, may refer to liquid waste including at least one of an organic decontamination agent and an inorganic decontamination agent.

In the present specification, the ‘organic decontamination agent’ may include one or more selected from the group consisting of oxalic acid, citric acid, formic acid, picolinic acid, ethylenediamine-N, N, N′,N′-tetraacetic acid (EDTA), gluconic acid, acetic acid, sulfamic acid, and the like. The ‘inorganic decontamination agent’ may include one or more selected from the group consisting of nitric acid, sulfuric acid, hydrochloric acid, hydrazine, and the like.

The ‘liquid scintillation counter liquid waste’ is not particularly limited as long as it is known for measuring radiation, such as a liquid scintillation material, a plastic scintillation material, and the like, and may be, for example, a scintillation material contained in liquid waste due to the use of a liquid scintillation counter (LSC) technology.

In the present invention, the ‘treatment of radioactive liquid waste’ refers to reducing the content of at least one of hardly degradable compounds such as an organic decontamination agent, an inorganic decontamination agent, and liquid scintillation material in radioactive liquid waste, and ultimately, may refer to substantially removing the same (that is, reducing the content of hardly degradable compounds such as the above in radioactive liquid waste to approximately 0%).

The method for treating radioactive liquid waste of the present invention includes: adding two or more selected from the group consisting of a metal ion, an oxidizing agent, air, oxygen, or nitrous oxide, and a semiconductor to radioactive liquid waste to prepare a pre-treatment solution; and irradiating the pre-treatment solution with irradiation.

When radioactive liquid waste is irradiated with radiation, an active material such as a hydrated electron, a radical, and a hydration ion, which are highly reactive, is generated, and the active material may decompose a hardly degradable compound in the radioactive liquid waste, for example, the material being at least one of an organic decontamination agent, an inorganic decontamination agent, and a liquid scintillation material.

An active material generated when water is irradiated with radiation may be represented by, for example, Equation 1 below, but is not limited thereto.

H₂O->e⁻_{aq}, H, .OH, H₂, H₂O₂, H⁺_{aq}, OH⁻_{aq} [Equation 1]

The method for treating radioactive liquid waste of the present invention includes, before radiation irradiation, adding two or more selected from the group consisting of a metal ion, an oxidizing agent, air, oxygen, or nitrous oxide, and a semiconductor to radioactive liquid waste to prepare a pre-treatment solution. The inventors of the present invention have found that, when treating radioactive liquid waste, if two or more among a metal ion, an oxidizing agent, air, oxygen, or nitrous oxide, and a semiconductor are added to the radioactive liquid waste followed by radiation irradiation, there is an increased effect (synergistic effect) in treatment efficiency for the radioactive waste liquid when compared to a treatment method in which each thereof is added followed by radiation irradiation, and have completed the present invention.

In the present invention, the ‘metal ion’ may be any metal ion, but is preferably a transition metal ion. For example, although not limited thereto, the metal ion may include one or more selected from the group consisting of a scandium ion, a titanium ion, a vanadium ion, a chromium ion, a manganese ion, an iron ion, a cobalt ion, a nickel ion, a copper ion, a zinc ion, a yttrium ion, a zirconium ion, a niobium ion, a molybdenum ion, a technetium ion, a ruthenium ion, a rhodium ion, a palladium ion, a silver ion, a cadmium ion, a hafnium ion, a tantalum ion, a tungsten ion, a rhenium ion, an osmium ion, an iridium ion, a platinum ion, a gold ion, and a mercury ion. In addition, it may be more preferable that the metal ion includes one or more selected from the group consisting of an iron ion, a copper ion, and a nickel ion. For example, the iron ion may exhibit a more excellent effect in terms of the rate of partially decomposing a hardly degradable compound (for example, an organic matter such as oxalic acid, an inorganic matter such as nitric acid, sulfuric acid, hydrochloric acid, and hydrazine, an organic scintillation material, and the like), and the copper ion and the nickel ion may exhibit a more excellent effect in terms of the rate of completely oxidizing oxalic acid and an organic matter such as liquid scintillation counter to carbon dioxide and decomposing an inorganic matter such as hydrazine, nitric acid, sulfuric acid, and hydrochloric acid.

When the radioactive liquid waste is added with the metal ion and then irradiated with radiation, there may be an effect of treating the radioactive liquid waste by activating the metal ion through a mechanism such as Equation 2 below. However, the reaction mechanism of the present invention is not limited thereto.

(When Radiation Irradiation is Performed)

H₂O->e⁻_{aq}, .H, .OH, H₂, H₂O₂, H⁺_{aq}, OH⁻_{aq}

M²⁺+H₂O₂->M³⁺+.OH+OH⁻ [Equation 2]

(Here, M²⁺ represents a metal ion and may specifically be a transition metal ion. An example thereof may be Fe²⁺, Cu²⁺, Ni²⁺, Al³⁺, and the like)

In an aspect, a transition metal ion may be included in the radioactive liquid waste, in which case the above effect may be achieved due to the transition metal ion in the radioactive liquid waste. Also, a transition metal ion may be additionally injected while considering the content of the transition metal ion in the radioactive liquid waste. The transition metal ion added may be of the same kind or of a different kind to the transition metal ion already present in the radioactive liquid waste, but is not limited thereto.

When there is a transition metal ion in the radioactive liquid waste, and/or when a transition metal ion is injected into the radioactive liquid waste, it is preferable that the concentration of the transition metal ion present in the radioactive liquid waste before radiation irradiation is, for example, 1-100 mM, specifically, 2-50 mM. When the content of the transition metal ion in the radioactive liquid waste before radiation irradiation is less than 1 mM, there may be a problem in which the treatment efficiency for a hardly degradable compound may be deteriorated. When the content of the transition metal ion is greater than 100 mM, the ion may rather act as a scavenger of a radical, so that there may be a problem in that the decomposition performance for a hardly degradable compound may be deteriorated.

In the present invention, the ‘oxidizing agent’ may include, although not limited to, for example, one or more selected from the group consisting of persulfate, peroxymonosulfate, sulfuric acid, hydrochloric acid, nitric acid, hydrogen peroxide, and a salt thereof. In terms of improving the treatment efficiency for radioactive waste liquid, it may be preferable that a compound that may form a sulfate radical is used as the oxidizing agent. The compound that may form a sulfate radical may be, although not limited to, for example, persulfate, peroxymonosulfate, sulfuric acid, and a salt thereof. Specifically, the ‘salt’ may include one or more selected from the group consisting of a potassium salt, a sodium salt and an ammonium salt.

The sulfate radical may be generated, for example, as shown in Equation 3 below, but is not limited thereto.

(When Radiation Irradiation is Performed)

2e⁻_{aq}+S₂O₈²⁻->2SO₄.⁻

e⁻_{aq}+HSO₅⁻->SO₄.⁻+OH⁻ [Equation 3]

In addition, in the present invention, when the semiconductor is irradiated, the semiconductor enters an excitation state, and since electron transfer is facilitated in the excitation state, an effect of excellently improving the production amount of hydroxyl radicals in the radioactive liquid waste may be exhibited. Accordingly, there may be an effect such as improving the treatment amount of the radioactive liquid waste, thereby reducing treatment costs.

As the semiconductor, although not limited to, for example, one or more selected from the group consisting of silicon, standium, titanium, vanadium, chromium, manganese, iron, cobalt, nickel, copper, zinc, gallium, yttrium, zirconium, molybdenum, lanthanum, cerium, tantalum, and an oxide thereof may be used. More specifically, the semiconductor may be, although not limited to, one doped with an organic element or an inorganic element. For example, one or more selected from the group consisting of transition metal oxides such as titanium dioxide, zinc oxide, and copper oxide may be used.

According to an aspect of the present invention, when treating radioactive liquid waste, a method of adding a metal ion and an oxidizing agent to radioactive liquid waste followed by radiation irradiation may exhibit an increased effect (synergistic effect) in treatment efficiency for the radioactive waste liquid when compared with a method of adding a metal ion and an oxidizing agent separately followed by radiation irradiation.

Particularly, in the present invention, by irradiating a pre-treatment solution including both an iron ion, a copper ion, a nickel ion, or a mixture thereof and a compound capable of forming a sulfate radical with radiation, an effect of maximizing the efficiency in treating radioactive liquid waste may be obtained.

More specifically, the inventors of the present invention have confirmed that the treatment efficiency for the radioactive waste liquid is much more excellently improved when the molar equivalent ratio of the metal ion and the oxidizing agent in the pre-treatment solution including a metal ion and an oxidizing agent is 1:1 to 1:10 (metal ion:oxidizing agent), preferably 1:1.5 to 1:8, more preferably 1:2 to 1:6, and most specifically, 1:2.5 to 1:5. In addition, according to an aspect of the present invention, when treating radioactive liquid waste, a method of adding a metal ion and air, oxygen, or nitrous oxide followed by radiation irradiation may exhibit a synergistic effect in decomposition efficiency for a hardly degradable compound when compared with a method of adding a metal ion and air, oxygen, or nitrous oxide separately followed by radiation irradiation.

More specifically, the molar equivalent ratio of the metal ion and air, oxygen, or nitrous oxide in the pre-treatment solution including a metal ion and air, oxygen, or nitrous oxide may be 1:0.001 to 1:100 (metal ion:air, oxygen, or nitrous oxide). In an embodiment, when the metal ion and oxygen were included in a molar equivalent ratio of 1:0.0221, and when the metal ion and nitrous oxide were included in a molar equivalent ratio of 1:63, it was confirmed that the treatment efficiency for radioactive waste liquid was much more excellently improved.

As an example, when the nitrous oxide was added to the pre-treatment solution followed by radiation irradiation, nitrous oxide dissolved in water rapidly reacts with a hydrated electron generated due to radiation irradiation to generate nitrogen gas and a hydroxyl radical (Equation 4), thereby suppressing the reaction between the hydrated electron and the hydroxyl radical, which results in the improvement in treatment efficiency for radioactive liquid waste due to the hydroxyl radical. However, the mechanism of the effect of improving the treatment efficiency by adding air, oxygen, or nitrous oxide is not limited thereto.

e⁻_{aq}+N₂O+H₂O→OH⁻+.OH+N₂ [Equation 4]

As mentioned above, when two or more selected from the group consisting of a metal ion, an oxidizing agent, air, oxygen, or nitrous oxide, and a semiconductor were added to radioactive liquid waste to prepare a pre-treatment solution, and then the pre-treatment solution was irradiated with radiation, the treatment efficiency for the radioactive liquid waste was confirmed to be significantly increased when compared with a case in which a metal ion, an oxidizing agent, air, oxygen, or nitrous oxide, or a semiconductor were separately added followed by radiation irradiation. However, a combination of two or more of the metal ion, the oxidizing agent, air, oxygen, or nitrous oxide, and the semiconductor is not limited to the above specific examples.

In the present invention, the radiation irradiation may be performed by, although not limited to, for example, irradiating one or more selected from the group consisting of an electron beam, an alpha ray, a beta rays, a gamma ray, an X-ray, an neutron ray. Preferably, the radiation irradiation may be performed with an electron beam, a gamma ray, or an X-ray. The radiation irradiation may be performed, although not limited to, for example, at an irradiation dose of 1-100 kGy based on an absorbed dose. In terms of reducing energy consumption and improving treatment efficiency, it may be preferable that the radiation irradiation is performed at an irradiation dose of 1-50 kGy.

In an embodiment, the inventors of the present invention have confirmed that when the radiation irradiation is performed at an irradiation dose of 5-25 kGy based on an absorbed dose, the synergistic effect of adding a metal ion and an oxidizing agent together to radioactive waste solution may be more excellent. Therefore, when a metal ion and an oxidizing agent are added together to radioactive liquid waste, it is most preferable that the radiation irradiation is performed at an irradiation dose of 5-25 kGy based on an absorbed dose.

In the present invention, the pH of the pre-treatment solution before the radiation irradiation is not particularly limited, but may be, for example, 2 to 13.

Since the pH of radioactive liquid waste generated at a nuclear power plant is typically 3 or less, studies have been mostly conducted on methods for treating radioactive liquid waste having a pH of 3 or less. However, as described above, according to the method for treating radioactive liquid waste of the present invention, the method including adding a combination of at least two of a metal ion, air, oxygen, or nitrous oxide, and a semiconductor to radioactive liquid waste followed by radiation irradiation, an excellent treatment efficiency for radioactive liquid waste may be exhibited without being limited to the pH of the radioactive liquid waste.

More specifically, the method for treating radioactive liquid waste according to the present invention is capable of treating radioactive liquid waste having a pH of 2 to 14. Particularly, the method may exhibit an excellent treatment efficiency for radioactive liquid waste having a pH of 7 to 10, and a pH of 8 to 9.5, thereby having an advantage of solving the problem of corrosion in a treatment device.

Hereinafter, Examples and the like will be described in detail to facilitate understanding of the present invention. However, Examples according to the present invention may be modified into other various forms, and the scope of the present invention should not be construed as being limited to Examples described below. Examples of the present invention are provided to more fully describe the present invention to those having ordinary skill in the art to which the present invention belongs.

### Comparative Experimental Example 1

### Comparison of UV/Hydrogen Peroxide Treatment and Radiation Treatment (pH 3)

In order to treat an organic acid and oxalic acid used as a complexing agent in a decontamination process at a nuclear power plant, a UV/hydrogen peroxide process and a radiation decomposition processing in which a metal ion and an oxidizing agent are added were used.

In the present experiment, an aqueous solution of oxalic acid having a concentration of 10 mM was prepared, and then the pH thereof was adjusted to 3 to prepare a solution to be treated. As the metal ion, a copper ion was used, and persulfate was used as the oxidizing agent. The molar equivalent of the copper ion and the persulfate was 1:5.

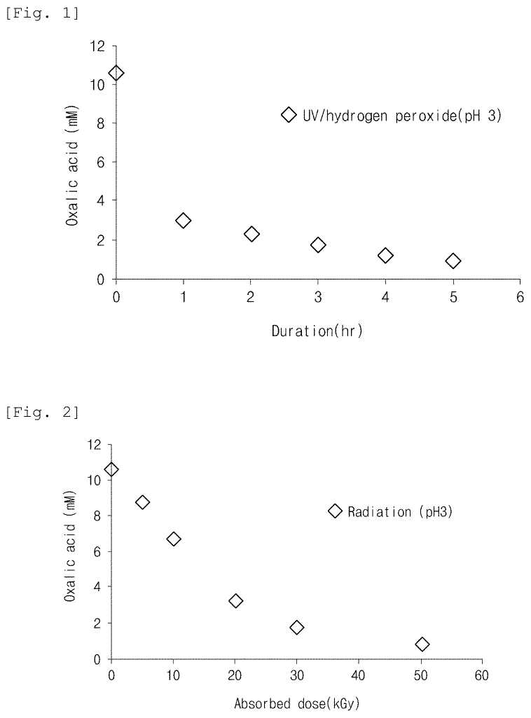

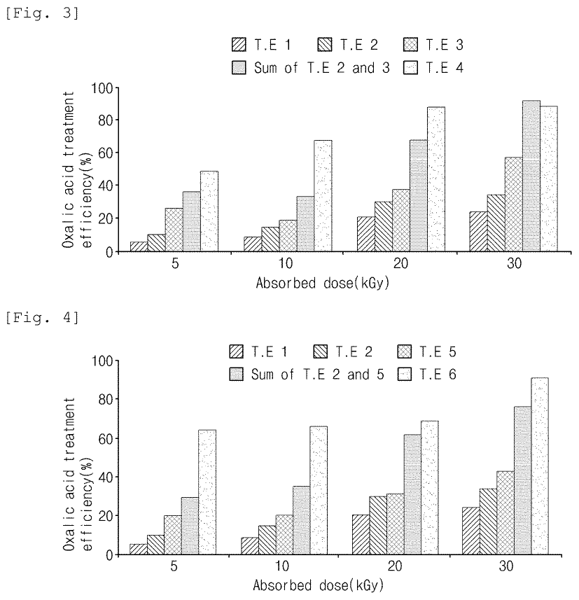

A medium-pressure ultraviolet lamp of 1 kW was used as UV, and hydrogen peroxide of 20 mM was added. UV irradiation was performed for 5 hours at a temperature condition of 35-55° C., and radiation irradiation was performed at an irradiation dose of 0, 10, 20, 30, and 50 kGy based on an absorbed dose. The results are shown in FIG. 1 and FIG. 2.

Referring to FIG. 1, when the oxalic acid was decomposed through the UV/hydrogen peroxide process, at pH 3, the oxalic acid was decomposed to 10 mM, 3.0 mM (decomposition rate: 69.8%), 2.3 mM (77%), 1.7 mM (82.7%), 1.2 mM (88%), and 1.0 mM (90.4%) at a duration of 0, 1, 2, 3, 4 and 5 hours, respectively, exhibiting the maximum treatment efficiency of 90.4% at 5 hours of duration.

In addition, referring to FIG. 2, when the oxalic acid was decomposed through the radiation irradiation, at pH 3, the oxalic acid was decomposed to 10 mM, 8.7 mM (decomposition rate: 16.7%), 6.8 mM (36.5%), 3.2 mM (69.5%), 1.7 mM (83.4%), and 0.8 mM (92.2%) at an irradiation dose of 0, 10, 20, 30 and 50 kGy, respectively, exhibiting the maximum treatment efficiency of 92.2% at the irradiation dose of 50 kGy.

As such, it was confirmed that the treatment efficiency for the radioactive waste liquid was excellent when the radiation process was used compared with when the UV/hydrogen peroxide process was used.

### Experimental Example 1

### Verification of Synergistic Effect of Adding Metal Ion and Oxidizing Agent Together During Radiation Treatment

In order to treat an organic acid and oxalic acid used as a complexing agent in a decontamination process at a nuclear power plant, an electron beam was used, and a radiation irradiation dose was 5, 10, 20, and 30 kGy. The concentration of the oxalic acid used in the present experiment was 2 mM, and the pH thereof was adjusted to 9.

A batch treated only with radiation (Treatment Example 1), a batch added with 2 mM of Fe(II) (Treatment Example 2), a batch added with 5 mM of S₂O₈²− (Treatment Example 3), and a batch added with 2 mM of Fe(II) and 5 mM of S₂O₈²⁻ (Treatment Example 4) were used for the experiment. The treatment efficiency (%) for oxalic acid was calculated by subtracting the content of remaining oxalic acid after the radiation irradiation from the content of oxalic acid before the radiation irradiation, and is shown in FIG. 3. In addition, in order to verify the synergistic effect of Treatment Example 4 in which the metal ion and the oxidizing agent were used together, FIG. 3 also shows the result of simply summing the oxalic acid treatment efficiency of each of Treatment Example 2 and Treatment Example 3.

First, referring to FIG. 3, it was confirmed that when a metal ion, an oxidizing agent, or a mixture thereof was included during radiation processing, excellent treatment efficiency was exhibited even at pH 9.

In addition, referring to FIG. 3, it was confirmed that when compared with a case in which either a metal ion or an oxidizing agent was added to radioactive liquid waste such as decontamination liquid waste including oxalic acid followed by radiation irradiation, the treatment efficiency of a case in which a metal ion and an oxidizing agent were all added followed by radiation irradiation was excellently improved. In addition, when a radiation irradiation dose was 5-20 kGy, it was confirmed that a case in which a metal ion and an oxidizing agent were all added (Treatment Example 4) exhibited a more excellent treatment effect than cases in which a metal ion and an oxidizing agent were respectively added (Treatment Examples 2 and 3), by exceeding the simple sum of the treatment efficiency of each thereof.

### Experimental Example 2

### Verification of Synergistic Effect of Adding Metal Ion and Oxygen Together During Radiation Treatment

In order to treat an organic acid and oxalic acid used as a complexing agent in a decontamination process at a nuclear power plant, an electron beam was used, and a radiation irradiation dose was 5, 10, 20, and 30 kGy. The concentration of the oxalic acid used in the present experiment was 2 mM, and the pH thereof was adjusted to 9.

A batch treated only with radiation (Treatment Example 1), a batch added with 2 mM of Fe(II) (Treatment Example 2), a batch added with 0.0442 mM of oxygen (Treatment Example 5), and a batch added with 2 mM of Fe(II) and 0.0442 mM oxygen (Treatment Example 6) were used for the experiment. The treatment efficiency (%) for oxalic acid was calculated by subtracting the content of remaining oxalic acid after the radiation irradiation from the content of oxalic acid before the radiation irradiation, and is shown in FIG. 4. In addition, in order to verify the synergistic effect of Treatment Example 6 in which a metal ion and oxygen were used together, FIG. 4 also shows the result of simply summing the oxalic acid treatment efficiency of each of Treatment Example 2 and Treatment Example 5.

First, referring to FIG. 4, it was confirmed that when a metal ion, oxygen, or a mixture thereof was included during radiation processing, excellent treatment efficiency was exhibited even at pH 9.

In addition, referring to FIG. 4, it was confirmed that when compared with a case in which either a metal ion or an oxygen was added to radioactive liquid waste followed by radiation irradiation, the treatment efficiency of a case in which a metal ion and an oxidizing agent were all added followed by radiation irradiation was excellently improved. In addition, when a radiation irradiation dose was 5-50 kGy, it was confirmed that a case in which a metal ion and an oxidizing agent were all added (Treatment Example 6) exhibited a more excellent treatment effect than cases in which a metal ion and an oxidizing agent were respectively added (Treatment Examples 2 and 5) by exceeding the simple sum of the treatment efficiency of each thereof.

### Experimental Example 3

### Verification of Effect of Injecting Air, Metal Ion, and Semiconductor During Radiation Treatment

In order to treat an organic acid and oxalic acid used as a complexing agent in a decontamination process at a nuclear power plant, a gamma ray was used, and a radiation irradiation dose was 5, 10, and 30 kGy. The concentration of the oxalic acid used in the present experiment was 2 mM, and the pH thereof was 2.5. The air was injected for 20 minutes by substitution and dissolution.

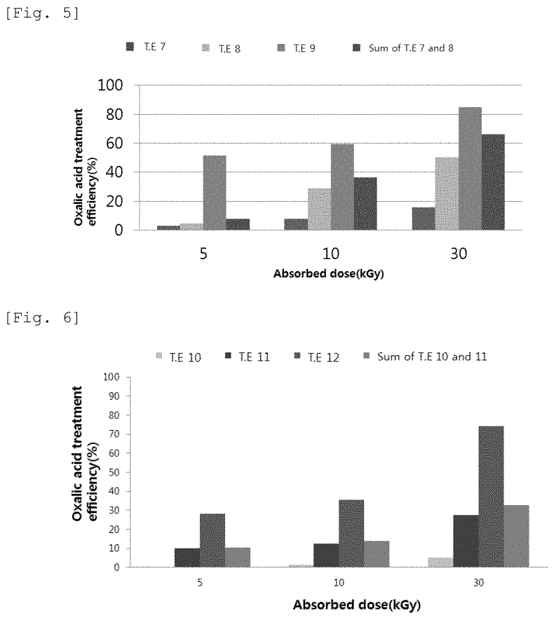

1 mM of a copper ion and 1 mM of titanium dioxide were respectively added as a metal ion and as a semiconductor to perform the experiment. Specifically, a batch in which the copper ion was added to radioactive liquid waste injected with air (Treatment Example 7), a batch in which titanium dioxide was added to radioactive liquid waste injected with air (Treatment Example 8), and a batch in which the copper ion and titanium dioxide were added to radioactive liquid waste injected with air (Treatment Example 9) were used for the experiment. The treatment efficiency (%) for oxalic acid was calculated by subtracting the content of remaining oxalic acid after the radiation irradiation from the content of oxalic acid before the radiation irradiation, and is shown in FIG. 5.

In order to verify the synergistic effect of Treatment Example 9 in which the metal ion and the semiconductor were treated together, FIG. 5 shows values obtained by summing the treatment efficiency of each of Treatment Example 7 and Treatment Example 8 in the graph.

As it can be confirmed in FIG. 5, when a gamma ray irradiation dose was 5, 10, and 30 kGy, the oxalic acid was removed by 3.2%, 7.8%, and 15.9%, respectively in the case of Treatment Example 7, and the oxalic acid was removed by 4.5%, 28.8%, and 50.5%, respectively in the case of Treatment Example 8. The oxalic acid was removed by 51.7%, 59.4%, and 85.0%, respectively in the case of Treatment Example 9.

### Experimental Example 4

### Verification of Effect of Injecting Air, Oxidizing Agent, and Oxygen During Radiation Treatment

In order to treat an organic acid and oxalic acid used as a complexing agent in a decontamination process at a nuclear power plant, a gamma ray was used, and radiation irradiation was performed at an irradiation dose of 5, 10 and 30 kGy. The concentration of the oxalic acid used in the present experiment was 2 mM, and the pH thereof was 2.5. The air was injected for 20 minutes by substitution and dissolution.

1 mM of persulfate was added as an oxidizing agent, and 0.04 mM of oxygen was added to perform the experiment. Specifically, a batch in which persulfate was added to radioactive liquid waste injected with air (Treatment Example 10), a batch in which oxygen was added to radioactive liquid waste injected with air (Treatment Example 11), and a batch in which persulfate and oxygen were added to radioactive liquid waste injected with air (Treatment Example 12) were used for the experiment. The treatment efficiency (%) for oxalic acid was calculated by subtracting the content of remaining oxalic acid after the radiation irradiation from the content of oxalic acid before the radiation irradiation, and is shown in FIG. 6.

In order to verify the synergistic effect of Treatment Example 12 in which the oxidizing agent and oxygen were treated together, FIG. 6 shows values obtained by summing the treatment efficiency of each of Treatment Example 10 and Treatment Example 11 in the graph.

As it can be confirmed in FIG. 6, when a gamma ray irradiation dose was 5, 10, and 30 kGy, the oxalic acid was removed by 0.4%, 1.4%, and 5.3%, respectively in the case of Treatment Example 10, and the oxalic acid was removed by 10.0%, 12.7%, 27.6%, respectively in the case of Treatment Example 11. The oxalic acid was removed by 28.3%, 35.7%, and 74.1%, respectively in the case of Treatment Example 12.

### Experimental Example 5

### Verification of Effect of Injecting Oxidizing Agent and Oxygen During Radiation Treatment

In order to treat hydrazine (N2H4) used as an inorganic decontamination agent in a decontamination process at a nuclear power plant, an electron beam was used, and a radiation irradiation dose was 5, 10, and 30 kGy. The concentration of the hydrazine used in the present experiment was 40 mM, and the pH thereof was to 3.

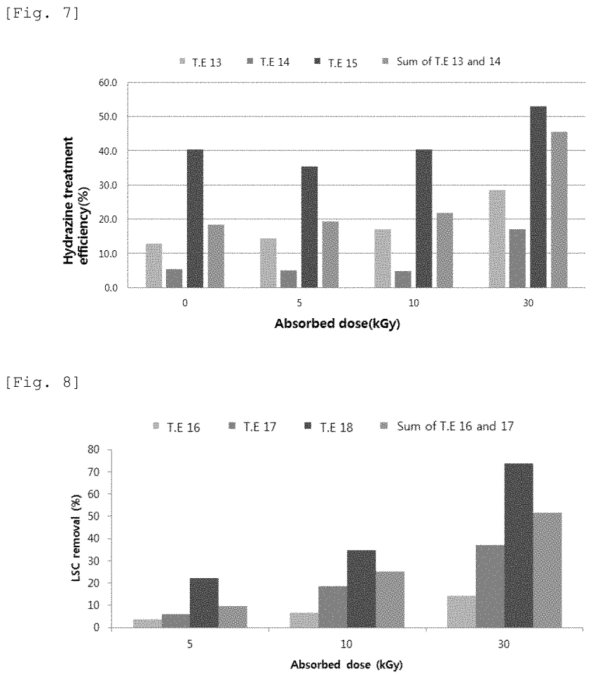

20 mM of persulfate (PDS) was added as an oxidizing agent, and 0.04 mM of oxygen was added to perform the experiment. Specifically, a batch in which persulfate was added to radioactive liquid waste (Treatment Example 13), a batch in which oxygen was added to radioactive liquid waste (Treatment Example 14), and a batch in which persulfate and oxygen were added to radioactive liquid waste (Treatment Example 15) were used for the experiment. The treatment efficiency (%) for hydrazine was calculated by subtracting the content of remaining hydrazine after the radiation irradiation from the content of hydrazine before the radiation irradiation, and is shown in FIG. 7.

In order to verify the synergistic effect of Treatment Example 15 in which the oxidizing agent and oxygen were treated together, FIG. 7 shows values obtained by summing the treatment efficiency of each of Treatment Example 13 and Treatment Example 14 in the graph.

As it can be confirmed in FIG. 7, when an electron beam irradiation dose was 5, 10, and 30 kGy, the hydrazine was removed by 14.3%, 17.0%, and 28.6%, respectively in the case of Treatment Example 13, and the hydrazine was removed by 5.1%, 4.8%, 17.0%, respectively in the case of Treatment Example 14. The hydrazine was removed by 35.4%, 40.4%, and 53.0%, respectively in the case of Treatment Example 15.

### Experimental Example 6

### Verification of Synergistic Effect of Metal Ion, Oxidizing Agent, Nitrous Oxide During Radiation Treatment (pH 3)

In order to treat liquid waste containing liquid scintillation counter (PerkinElmer Co.'s CarboSorb E and Permaflour E⁺ were mixed at 1:1 to be used), a gamma ray was used, and a radiation irradiation dose was 5, 10, and 30 kGy. The total organic carbon (TOC) of the liquid waste containing liquid scintillation counter (LSC) used in the present experiment was 45-60 mg/L, and the pH thereof was prepared to be 3 using 0.1 N of nitric acid.

Fe²⁺ was added to 1 mM as a metal ion, and N₂O was injected at a rate of 0.1 MPa/10 mL for 20 minutes. Persulfate was added to 1 mM as an oxidizing agent.

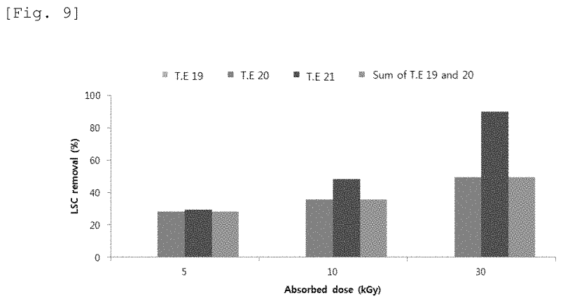

Specifically, a batch in which only the metal ion was added to liquid scintillation counter (LSC) liquid waste (Treatment Example 16), a batch in which the oxidizing agent and nitrous oxide were added to liquid scintillation counter (LSC) liquid waste (Treatment Example 17), and a batch in which the metal ion, the oxidizing agent, and nitrous oxide were added to liquid scintillation counter (LSC) liquid waste (Treatment Example 18) were used for the experiment. The treatment efficiency (%) for liquid scintillation counter (LSC) was calculated by subtracting the total organic carbon (TOC) concentration of liquid scintillation counter (LSC) liquid waste after the radiation irradiation from the total organic carbon (TOC) concentration thereof before the radiation irradiation, and is shown in FIG. 8.

In order to verify the synergistic effect of Treatment Example 18 in which the metal ion, the oxidizing agent, and nitrous oxide were treated together, FIG. 8 shows values obtained by summing the treatment efficiency of each of Treatment Example 16 and Treatment Example 17 in the graph.

As it can be confirmed in FIG. 8, when a gamma ray irradiation dose was 5, 10, and 30 kGy, the treatment efficiency was 3.7%, 6.6%, and 14.2%, respectively in the case of Treatment Example 16, and the treatment efficiency was 6%, 18.4%, and 37.1%, respectively in the case of Treatment Example 17. The treatment efficiency was 22.1%, 34.6%, and 73.9%, respectively in the case of Treatment Example 18.

### Experimental Example 7

### Verification of Synergistic Effect of Metal Ion, Oxidizing Agent, Nitrous Oxide During Radiation Treatment (pH 7)

The experiment was performed in the same manner as in Experimental Example 6 except that liquid scintillation counter (LSC) liquid waste of pH 7 was used and Cu²⁺ was added to 1 mM as a metal ion, and the result is shown in FIG. 9. Specifically, a batch in which only the metal ion was added to liquid scintillation counter (LSC) liquid waste (Treatment Example 19), a batch in which the oxidizing agent and nitrous oxide were added to liquid scintillation counter (LSC) liquid waste (Treatment Example 20), and a batch in which the metal ion, the oxidizing agent, and nitrous oxide were added to liquid scintillation counter (LSC) liquid waste (Treatment Example 21) were used for the experiment.

As it can be confirmed in FIG. 9, when a gamma ray irradiation dose was 5, 10, and 30 kGy, the treatment efficiency was 0%, respectively in the case of Treatment Example 19, and the treatment efficiency was 28.1%, 35.7%, and 49.4%, respectively in the case of Treatment Example 21. The treatment efficiency was 29.5%, 48.4%, and 89.8%, respectively in the case of Treatment Example 21.

1. A method for treating radioactive liquid waste the method comprising:
adding two or more selected from the group consisting of a metal ion, an oxidizing agent, oxygen or nitrous oxide, air, and a semiconductor to radioactive liquid waste, or adding one or more selected from the group consisting of an oxidizing agent, oxygen or nitrous oxide, air, and a semiconductor to radioactive liquid waste containing a metal ion to prepare a pre-treatment solution; and
irradiating the pre-treatment solution with radiation.

2. The method of claim 1, wherein the metal ion is a transition metal ion.

3. The method of claim 2, wherein the transition ion comprises one or more selected from the group consisting of a scandium ion, a titanium ion, a vanadium ion, a chromium ion, a manganese ion, an iron ion, a cobalt ion, a nickel ion, a copper ion, a zinc ion, a yttrium ion, a zirconium ion, a niobium ion, a molybdenum ion, a technetium ion, a ruthenium ion, a rhodium ion, a palladium ion, a silver ion, a cadmium ion, a hafnium ion, a tantalum ion, a tungsten ion, a rhenium ion, an osmium ion, an iridium ion, a platinum ion, a gold ion, and a mercury ion.

4. The method of claim 3, wherein the transition metal ion is an iron ion, a copper ion, a nickel ion, or a mixture thereof.

5. The method of claim 1, wherein the oxidizing agent comprises one or more selected from the group consisting of persulfate, sulfuric acid, peroxymonosulfate, hydrochloric acid, nitric acid, hydrogen peroxide, and a salt thereof.

6. The method of claim 5, wherein the oxidizing agent is a compound capable of forming a sulfate radical by radiation irradiation.

7. The method of claim 6, wherein the compound capable of forming a sulfate radical by radiation irradiation comprises one or more selected from the group consisting of persulfate, sulfuric acid, peroxymonosulfate, and a salt thereof.

8. The method of claim 1, wherein the semiconductor is doped with an organic element or an inorganic element.

9. The method of claim 1, wherein the preparing of a pre-treatment solution comprises preparing radioactive waste liquid including the metal ion and the oxidizing agent.

10. The method of claim 9, wherein the molar equivalent ratio of the metal ion and the oxidizing agent in the pre-treatment solution is 1:1 to 1:10.

11. The method of claim 10, wherein the molar equivalent ratio of the metal ion and the oxidizing agent is 1:2 to 1:5.

12. The method of claim 1, wherein the preparing of a pre-treatment solution is either adding a metal ion and air, oxygen, or nitrous oxide to the radioactive waste liquid, or adding air, oxygen, or nitrous oxide to the radioactive waste liquid containing the metal ion.

13. The method of claim 12, wherein the molar equivalent ratio of the metal ion and air, oxygen, or nitrous oxide is 1:0.001 to 1:100.

14. The method of claim 1, wherein the radiation irradiation is irradiating one or more selected from the group consisting of an electron beam, an alpha ray, a beta ray, a gamma ray, an X-ray, an neutron ray.

15. The method of claim 1, wherein an irradiation dose of the radiation irradiation is 1 to 100 kGy based on an absorbed dose.

16. The method of claim 9, wherein an irradiation dose of the radiation irradiation is 5 to 25 kGy based on an absorbed dose.

17. The method of claim 1, wherein the pH of the radioactive liquid waste is 2 to 13.

18. The method of claim 1, wherein the radioactive waste liquid comprises at least one hardly degradable compound selected from the group consisting of an organic decontamination agent, an inorganic decontamination agent, and liquid scintillation counter liquid waste, and the treating of the radioactive waste liquid comprises removing the hardly degradable compound.

19. The method of claim 18, wherein the organic decontamination agent comprises one or more selected from the group consisting of oxalic acid, citric acid, formic acid, picolic acid, ethylenediamine-N, N, N′, N′-tetraacetic acid (EDTA), gluconic acid, acetic acid, and sulfamic acid.

20. The method of claim 18, wherein the inorganic decontamination agent comprises one or more selected from the group consisting of nitric acid, sulfuric acid, hydrochloric acid, and hydrazine.
